(19) United States
(12) Patent Application Publication
(10) Pub. No.: US 2025/0003749 A1
(43) Pub. Date: Jan. 2, 2025

(54) VIRTUAL MIRROR GRAPHICAL REPRESENTATION FOR PREDICTIVE COLLISION ANALYSIS

(71) Applicant: FARO Technologies, Inc., Lake Mary, FL (US)

(72) Inventor: Paul Hetherington, Kamloops (CA)

(73) Assignee: FARO Technologies, Inc., Lake Mary, FL (US)

(21) Appl. No.: 18/757,988

(22) Filed: Jun. 28, 2024

Related U.S. Application Data
(60) Provisional application No. 63/510,741, filed on Jun. 28, 2023.

(51) Int. Cl. G01C 11/36; B60R 1/22; G01C 11/02; G06T 17/00

(52) U.S. Cl. CPC G01C 11/36; B60R 1/22; G01C 11/025; G06T 17/00; G06T 2200/08

(57) ABSTRACT

Examples described herein provide a method for performing a predictive collision analysis. The method includes initiating, on a processing system, the predictive collision analysis to be performed on the processing system. The further method includes defining a virtual mirror property for a virtual mirror for the predictive collision analysis. The method further includes performing, by the processing system, the predictive collision analysis. Performing the predictive collision analysis includes generating a virtual mirror graphical representation including the virtual mirror based on the virtual mirror property.

### CROSS-REFERENCE TO RELATED APPLICATION

This application claims the benefit of U.S. Provisional Patent Application Ser. No. 63/510,741, filed Jun. 28, 2023 and entitled “Virtual Mirror Graphical Representation For Predictive Collision Analysis,” the contents of which, including all color drawings, are incorporated by reference herein in their entirety. Cross reference is also made to U.S. Provisional Patent Application Ser. No. 63/459,074, filed on Apr. 13, 2023 and entitled “Predictive Collision Analysis Based On Inputs From A Gaming Controller,” the contents of which, including all color drawings, are incorporated by reference herein in their entirety. Cross reference is further made to International Application (PCT) No. PCT/US2024/023985, filed on Apr. 11, 2024 and entitled “Predictive Collision Analysis Based On Inputs From A Gaming Controller,” the contents of which are incorporated by reference herein in their entirety.

### BACKGROUND

The subject matter disclosed herein relates to a system for predicting or simulating a vehicle collision. The electronic model makes use of a three-dimensional (3D) coordinate measurement device, such as a laser scanner time-of-flight (TOF) coordinate measurement device referred to as a “TOF scanner,” “3D laser scanner,” or “laser scanner.” A 3D laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A TOF laser scanner is a scanner in which the distance to a target point is determined based on the speed of light in air between the scanner and a target point. Laser scanners are typically used for scanning closed or open spaces such as interior areas of buildings, industrial installations and tunnels. They also are used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

### BRIEF DESCRIPTION

In one exemplary embodiment, a method is provided for performing a predictive collision analysis. The method includes initiating, on a processing system, the predictive collision analysis to be performed on the processing system, the predictive collision analysis being based on an environment of a vehicle collision. The further method includes defining a virtual mirror property for a virtual mirror for the predictive collision analysis, the virtual mirror depicting rear views of a vehicle in the vehicle collision. The method further includes performing, by the processing system, the predictive collision analysis. Performing the predictive collision analysis includes generating a virtual mirror graphical representation including the virtual mirror based on the virtual mirror property.

In another embodiment a system includes a memory including computer readable instruction and a processing device for executing the computer readable instructions. The computer readable instructions control the processing device to perform operations for performing a predictive collision analysis. The operations include initiating the predictive collision analysis to be performed. The operations further include defining a virtual mirror property for a virtual mirror for the predictive collision analysis. The operations further include performing the predictive collision analysis, wherein performing the predictive collision analysis includes generating a virtual mirror graphical representation including the virtual mirror based on the virtual mirror property.

The above features and advantages, and other features and advantages, of the disclosure are readily apparent from the following detailed description when taken in connection with the accompanying drawings.

### BRIEF DESCRIPTION OF DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 is a perspective view of a laser scanner according to one or more embodiments described herein;

FIG. 2 is a side view of the laser scanner illustrating a method of measurement according to one or more embodiments described herein;

FIG. 3 is a schematic illustration of the optical, mechanical, and electrical components of the laser scanner according to one or more embodiments described herein;

FIG. 4 is a schematic illustration of the laser scanner of FIG. 1 according to one or more embodiments described herein;

FIG. 5 is a schematic illustration of a processing system for predictive collision analysis according to one or more embodiments described herein;

FIG. 6 is a graphical representation of a predictive collision analysis;

FIG. 7 is a flow diagram of a method for generating a virtual mirror graphical representation for predictive collision analysis according to one or more embodiments described herein;

FIG. 8 is an interface defining virtual mirror properties for virtual mirrors according to one or more embodiments described herein;

FIGS. 9A-9D are interfaces showing a graphical representation for a predictive collision analysis where the graphical representation includes virtual mirror graphical representations according to one or more embodiments described herein;

FIGS. 10A-10C are interfaces showing a graphical representation for a predictive collision analysis where the graphical representation includes virtual mirror graphical representations according to one or more embodiments described herein; and

FIG. 11 is a schematic illustration of a processing system for implementing the presently described techniques according to one or more embodiments described herein.

The detailed description explains embodiments of the disclosure, together with advantages and features, by way of example with reference to the drawings.

### DETAILED DESCRIPTION

Embodiments described herein provide for a virtual mirror graphical representation for predictive collision analysis.

Three-dimensional (3D) coordinate measurement devices, such as laser scanners, are used to captured 3D data about an environment, such as the location where a vehicle collision (or collisions) has occurred for example. The 3D data is presented on a device, such as a smartphone, tablet, heads-up display, etc., as a graphical representation. In some cases, the graphical representation is a point cloud, which is a collection of points (e.g., the 3D data), where each point is defined by coordinate (x, y, z).

One application where 3D scanners are used is to scan an environment, such as a location where a vehicle collision has occurred. Using the data acquired by the 3D scanner, a user uses a simulation collision analysis in an attempt to recreate the vehicle collision. Depending on the complexity of the simulation, such based as the number of vehicles involved and environmental conditions for example, the recreation of the vehicle collision is a time consuming process that involved many iterations of manually changing parameters of the vehicles and comparing the results to actual data.

Accordingly, while existing collision simulation or prediction systems are suitable for their intended purposes, what is needed is a collision simulation or prediction system having certain features of embodiments described herein.

Another use case for 3D data is for predictive collision analysis. For example, when an incident (e.g., a collision between vehicles) occurs, investigators and forensic experts desire to establish facts and document the incident, which is useful for collision reconstruction, crime and fire investigation, courtroom presentation creation, and/or the like including combinations and/or multiples thereof. Accordingly, a 3D coordinate measurement device is used to document an environment where the incident occurred. For example, the 3D coordinate measurement device collects 3D data about the environment so the environment is virtually/digitally recreated and used for collision reconstruction and the like. In some cases, images and/or video is taken of the environment and used to create 3D data about the environment using photogrammetry and/or videogrammetry techniques.

Predictive collision analysis is the process of predicting or simulating an incident using data about the environment where the incident occurred (e.g., 3D data collected by the 3D coordinate measurement device or created from images or video) and/or prediction properties. Non-limiting examples of such incidents include a collision between or among vehicles, a collision between a vehicle and a pedestrian, a collision between a vehicle and a stationary object, and/or the like including combinations and/or multiples thereof. A vehicle includes, but is not limited to, a car, truck, van, bus, boat/ship, airplane, bicycle, motorcycle, and/or the like including combinations and/or multiples thereof. Prediction properties are user defined, estimated/calculated, or measured (e.g., from a vehicle's event data recorder). For example, a vehicle's event data recorder (or “black box”) data is used in the simulation to define prediction properties; however, such event data records often records a few seconds of data before the crash, which in some instances is not a long enough duration to be used to create the events that led up to the collision. The terms “predicting” and “simulating” are used interchangeably herein, except where noted otherwise.

In some cases, the predictive collision analysis is used for reconstruction an incident that has occurred in the past. Predictive collision analysis uses a virtual environment corresponding to a real-world environment to simulate the incident and uses one or more virtual vehicles to simulate real-world vehicles involved in the incident. Predictive collision analysis is useful for evaluating an incident, such as to determine liability or understand how the incident occurred. In other cases, the predictive collision analysis is used for evaluating an environment for potential incidents that might occur in the future. This is useful for evaluating environments, such as before construction, roadwork, etc. is performed to minimize the likelihood of incidents occurring. For example, if a new interchange is being designed, predictive collision analysis is performed to evaluate the new interchange design to determine a likelihood of different incidents occurring.

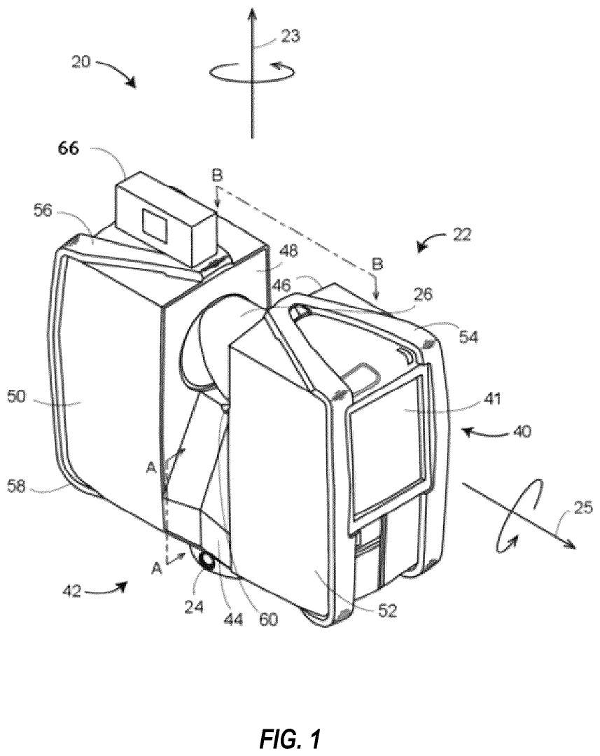

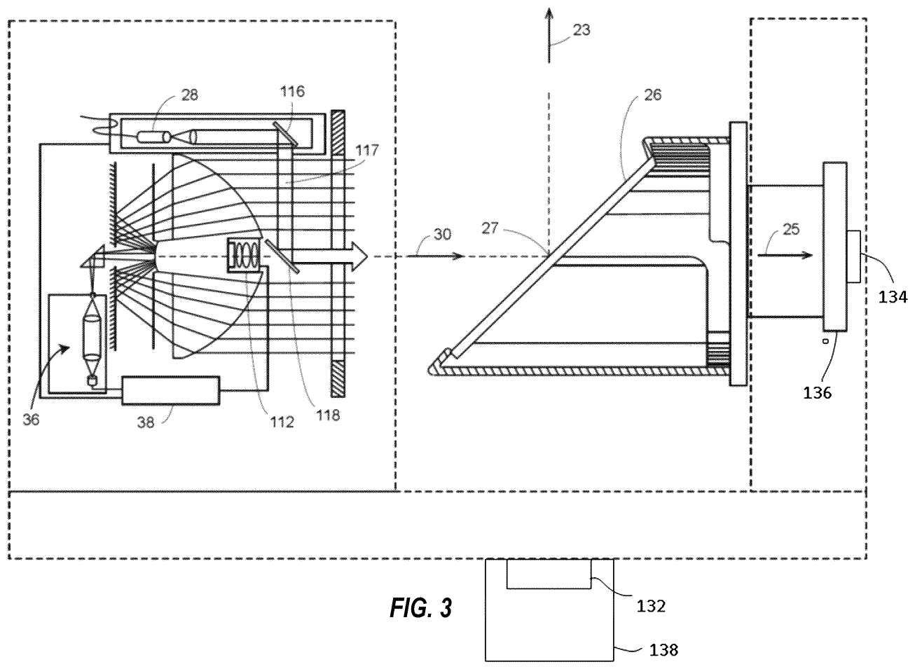

Referring now to FIGS. 1-3, a 3D coordinate measurement device, such as a laser scanner 20, is shown for optically scanning and measuring the environment surrounding the laser scanner 20 according to one or more embodiments described herein. The laser scanner 20 has a measuring head 22 and a base 24. The measuring head 22 is mounted on the base 24 such that the laser scanner 20 is rotated about a vertical axis 23. In one embodiment, the measuring head 22 includes a gimbal point 27 that is a center of rotation about the vertical axis 23 and a horizontal axis 25. The measuring head 22 has a rotary mirror 26, which is rotated about the horizontal axis 25. The rotation about the vertical axis is about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis may be substituted for the terms vertical axis and horizontal axis, respectively. The terms pan axis or standing axis may also be used as an alternative to vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. The laser beam has a wavelength range of approximately 300 to 1500 nanometers, for example 790 nanometers, 905 nanometers, 1550 nm, or less than 400 nanometers. It should be appreciated that other electromagnetic radiation beams having greater or smaller wavelengths are also used. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary mirror 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the laser scanner 20 also collects gray-scale information related to the received optical power (equivalent to the term “brightness.”) The gray-scale value is determined at least in part, for example, by integration of the bandpass-filtered and amplified signal in the light receiver 36 over a measuring period attributed to the object point X.

The measuring head 22 includes a display device 40 integrated into the laser scanner 20. The display device 40 includes a graphical touch screen 41, as shown in FIG. 1, which allows the operator to set the parameters or initiate the operation of the laser scanner 20. For example, the screen 41 has a user interface that allows the operator to provide measurement instructions to the device, and the screen also displays measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 are coupled to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d depend on signal strength, which is measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 is used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 (′012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

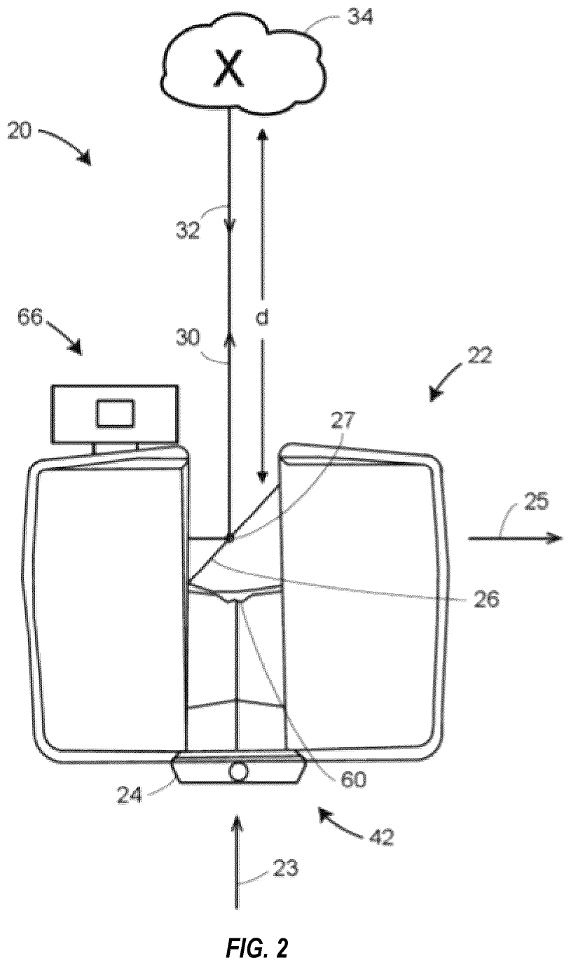

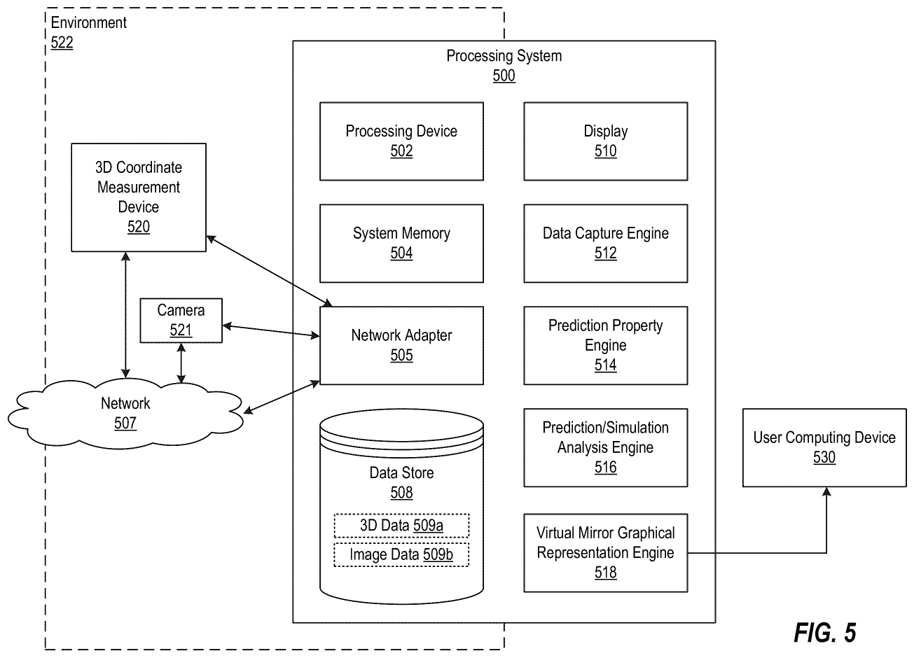

An auxiliary image acquisition device 66 is a device that captures and measures a parameter associated with the scanned area or the scanned object and provides a signal representing the measured quantities over an image acquisition area. The auxiliary image acquisition device 66 is, but is not limited to, a pyrometer, a thermal imager, an ionizing radiation detector, or a millimeter-wave detector. In an embodiment, the auxiliary image acquisition device 66 is a color camera with an ultrawide-angle lens, sometimes referred to as a “ultrawide-angle camera” or a “panoramic camera.” In an embodiment, as shown in FIGS. 1 and 2, the auxiliary image acquisition device 66 is physically coupled to and/or integrated with the laser scanner 20. In another embodiment, the auxiliary image acquisition device 66 is separate from, but associated with, the laser scanner 20. For example, a camera 104 (e.g., the auxiliary image acquisition device 66) is associated with a 3D scanner 102 (e.g., the laser scanner 20), as shown in FIG. 5A.

In an embodiment, a central color camera (first image acquisition device) 112 is located internally to the scanner and has the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 is near an infrared laser light (for example, light at wavelengths of 780 nm or 1250 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view is easily obtained by simply adjusting the steering mechanisms of the scanner—for example, by adjusting the azimuth angle about the axis 23 and by steering the mirror 26 about the axis 25.

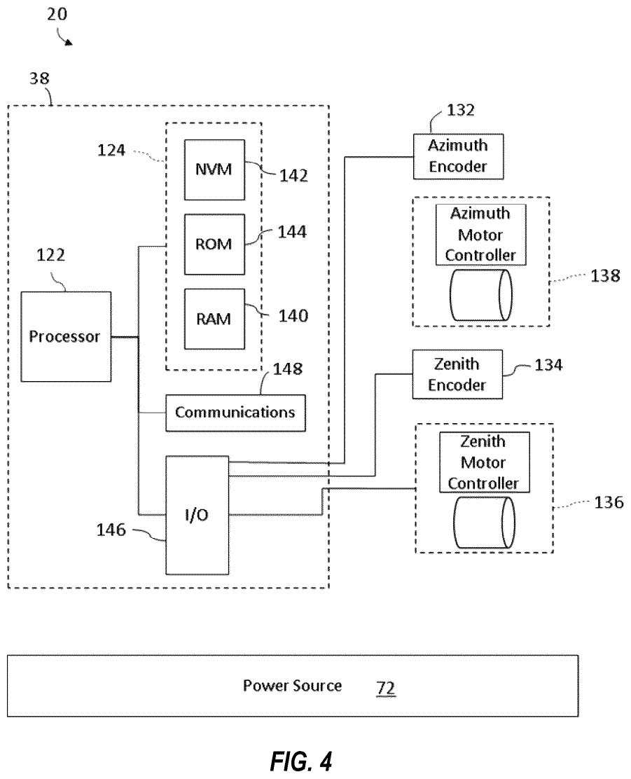

Referring now to FIG. 4 with continuing reference to FIGS. 1-3, elements are shown of the laser scanner 20. Controller 38 is a suitable electronic device capable of accepting data and instructions, executing the instructions to process the data, and presenting the results. The controller 38 includes one or more processing elements 122. The processors are microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 is displayed on a user interface 40 coupled to controller 38. The user interface 40 is one or more LEDs (light-emitting diodes) 82, an LCD (liquid-crystal diode) display, a CRT (cathode ray tube) display, a touch-screen display or the like. A keypad is also coupled to the user interface for providing data input to controller 38. In one embodiment, the user interface is arranged or executed on a mobile computing device that is coupled for communication, such as via a wired or wireless communications medium (e.g. Ethernet, serial, USB, Bluetooth™ or WiFi) for example, to the laser scanner 20.

The controller 38 is also coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet Protocol), RS-232, ModBus, and/or the like including combinations and/or multiples thereof. Additional systems 20 are also connected to LAN with the controllers 38 in each of these systems 20 being configured to send and receive data to and from remote computers and other systems 20. The LAN is connected to the Internet. This connection allows controller 38 to communicate with one or more remote computers connected to the Internet.

The processors 122 are coupled to memory 124. The memory 124 includes random access memory (RAM) device 140, a non-volatile memory (NVM) device 142, and a read-only memory (ROM) device 144. In addition, the processors 122 are connected to one or more input/output (I/O) controllers 146 and a communications circuit 148. In an embodiment, the communications circuit 92 provides an interface that allows wireless or wired communication with one or more external devices or networks, such as the LAN discussed above.

Controller 38 includes operation control methods embodied in application code (e.g., program instructions executable by a processor to cause the processor to perform operations). These methods are embodied in computer instructions written to be executed by processors 122, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

It should be appreciated that while embodiments herein describe the 3D coordinate measurement device as being a laser scanner, this is for example purposes and the claims should not be so limited. In other embodiments, the 3D coordinate measurement device is another type of system that measures a plurality of points on surfaces (i.e., generates a point cloud), such as but not limited to a triangulation scanner, a structured light scanner, a photogrammetry device, a light detection and ranging (LIDAR) device, and/or the like including combinations and/or multiples thereof, for example.

FIG. 5 is a schematic illustration of a processing system 500 for predictive collision analysis according to one or more embodiments described herein. The processing system 500 receives 3D data, such as from a 3D coordinate measurement device 520, and/or image data, such as from a camera 521 (e.g., a panoramic camera, a 360 degree camera, and/or the like including combinations and/or multiples thereof). The 3D data and the image data is captured in or in proximity to an environment 522, such as scene of an incident (e.g., a collision between vehicles). It should be appreciated that one or multiple 3D coordinate measurement devices are used in various embodiments. According to one or more embodiments described herein, the 3D coordinate measurement device 520 is used to take multiple scans. For example, the 3D coordinate measurement device 520 captures first scan data at a first scan point and then be moved to a second scan point, where the 3D coordinate measurement device 520 captures second scan data.

It should further be appreciated that while embodiments herein refer to the predictive collision analysis being performed on or within an electronic model of the environment that is created using a scanning device, such as 3D coordinate measurement device 520 for example, this is for example purposes and the claims should not be so limited. In other embodiments, the electronic model is generated using a commercial data source, such as Google Earth® for example, where the electronic model is temporally acquired at a different point(s) in time from the collision. In some embodiments, the electronic model is generated at different temporal points using a variety of methods, including but not limited to satellite images, aircraft photogrammetry, aircraft mounted LIDAR, or ground vehicle mounted LIDAR systems.

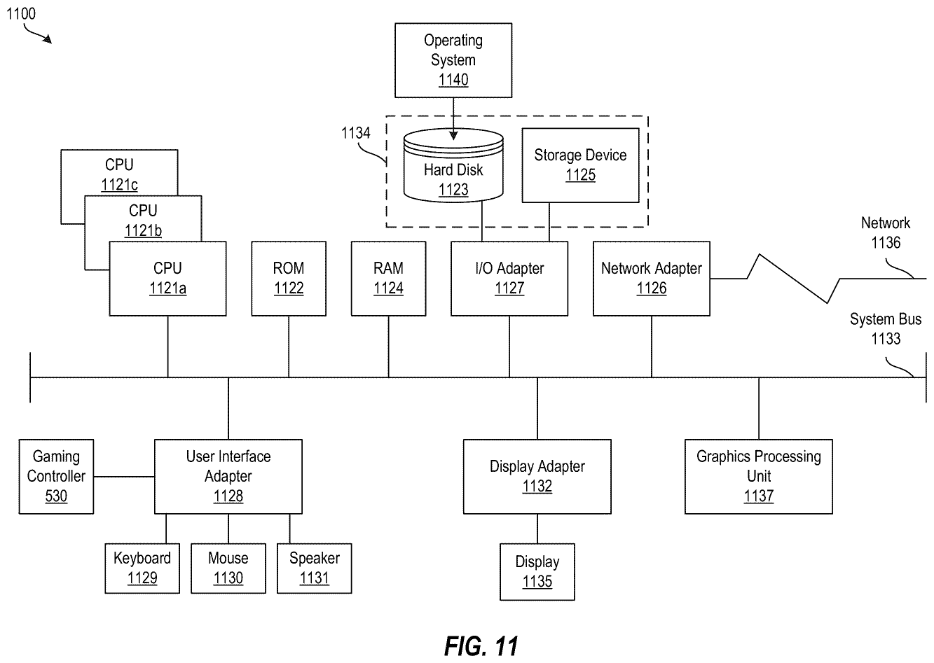

The processing system 500 is any suitable computing device, such as a laptop computer, a desktop computer, a smartphone, a tablet computer, and/or the like, including combinations and/or multiples thereof. FIG. 11 depicts a processing system 1100, which is an example of the processing system 500. As shown in FIG. 5, the processing system 500 includes a processing device 502 (e.g., one or more of the processing devices 1121 of FIG. 11), a system memory 504 (e.g., the RAM 1124 and/or the ROM 1122 of FIG. 11), a network adapter 506 (e.g., the network adapter 1126 of FIG. 11), a data store 508, a display 510, sensor(s) 511, a data capture engine 512, a prediction property engine 514, an prediction/simulation analysis engine 516, and a virtual mirror graphical representation engine 518.

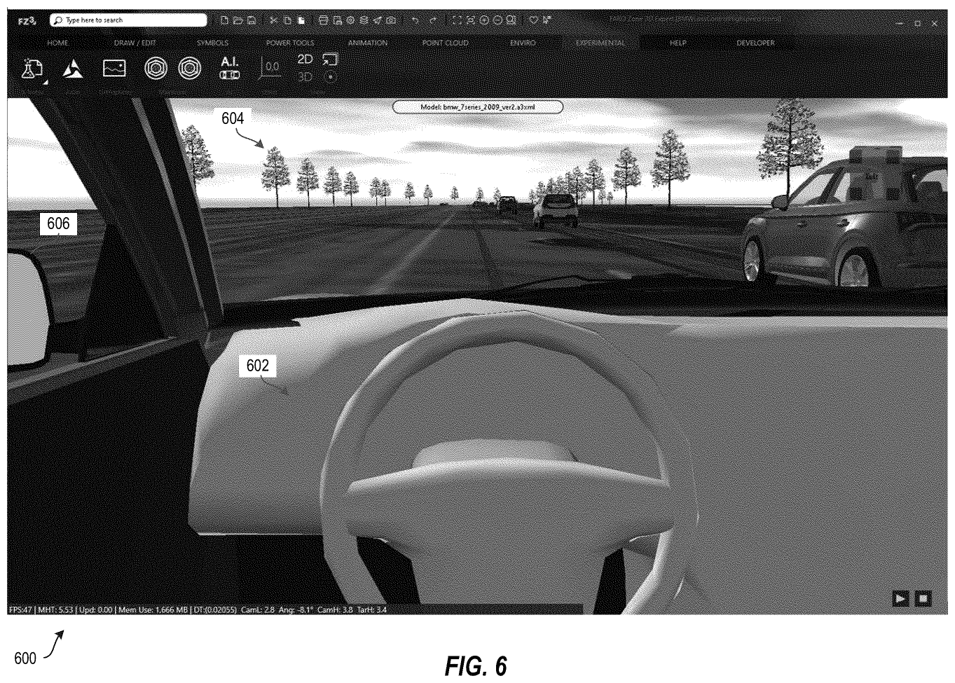

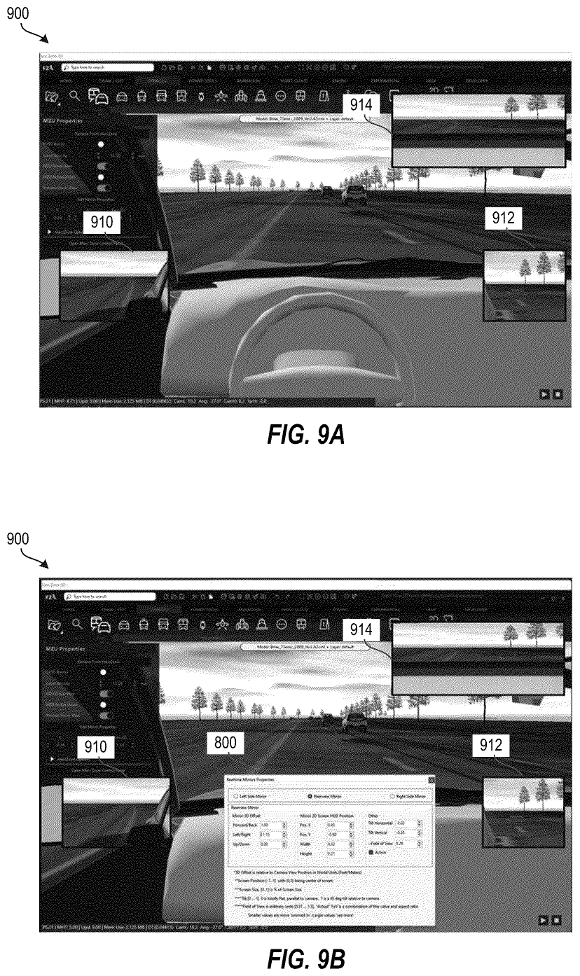

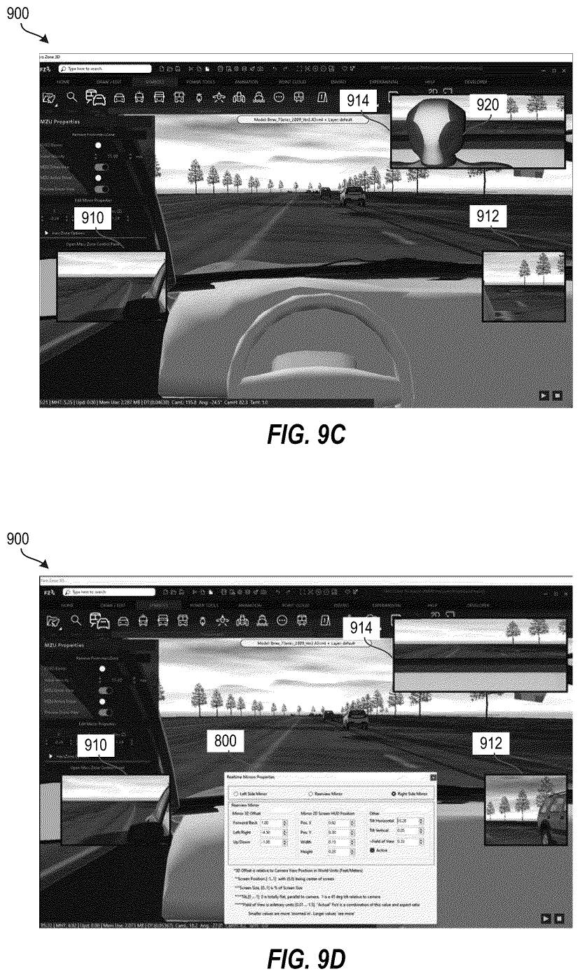

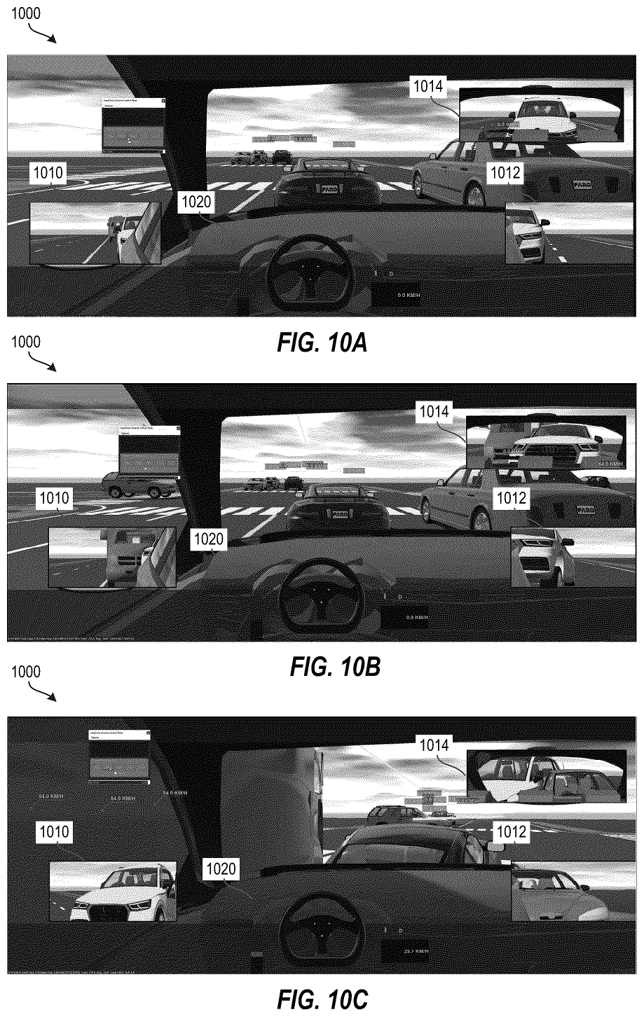

The data capture engine 512 is used to cause the 3D coordinate measurement device 520 and/or the camera 521 to capture data and/or images about the environment 522. The prediction property engine 514 is used to define prediction properties for performing a predictive collision analysis. The prediction/simulation analysis engine 516 is used to perform the predictive collision analysis. The virtual mirror graphical representation engine 518 is used to generate a virtual mirror graphical representation (see, e.g., FIGS. 9A-9D and 10A-10C) during and/or after the predictive collision analysis. Using one or more of the engines 512, 514, 516, 518, a user defines one or more virtual mirror graphical representations for displaying during the predictive collision analysis. The virtual mirror graphical representations are generated by rendering a scene of the environment 522 multiple times (e.g., one time for each virtual mirror graphical representation) and rendering the results to the graphical representation (e.g., the graphical representation 600 of FIG. 6) generated during the predictive collision analysis. The virtual mirror graphical representations are generated concurrently with the graphical representation to maintain synchronization between the graphical representation and the virtual mirror graphical representations.

The various components, modules, engines, etc. described regarding FIG. 5 (e.g., the data capture engine 512, the prediction property engine 514, the prediction/simulation analysis engine 516, and the virtual mirror graphical representation engine 518) is implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein is a combination of hardware and programming. The programming is processor executable instructions stored on a tangible memory, and the hardware includes the processing device 502 for executing those instructions. Thus, the system memory 504 stores program instructions that when executed by the processing device 502 implement the engines described herein. Other engines are also utilized to include other features and functionality described in other examples herein.

The network adapter 506 enables the processing system 500 to transmit data to and/or receive data from other sources, such as the 3D coordinate measurement device 520 and/or the camera 521. For example, the processing system 500 receives 3D data (e.g., a data set that includes a plurality of three-dimensional coordinates of the environment 522) from the 3D coordinate measurement devices 520 directly and/or via a network 507. The 3D data from the 3D coordinate measurement device 520 is stored in the data store 508 of the processing system 500 as 3D data 509a, which is used to display a point cloud on the display 510. As another example, the processing system 500 receives image data (e.g., panoramic images of the environment 522) from the camera 521 directly and/or via the network 507. The image data from the camera 521 is stored in the data store 508 of the processing system 500 as image data 509b, which is displayed on the display 510.

The network 507 represents any one or a combination of different types of suitable communications networks such as, for example, cable networks, public networks (e.g., the Internet), private networks, wireless networks, cellular networks, or any other suitable private and/or public networks. Further, the network 507 has any suitable communication range associated therewith and includes, for example, global networks (e.g., the Internet), metropolitan area networks (MANs), wide area networks (WANs), local area networks (LANs), or personal area networks (PANs). In addition, the network 507 includes any type of medium over which network traffic is carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

According to an embodiment, during a predictive collision analysis, a digital representation of the environment is generated from the point of view of the interior of a vehicle. For example, FIG. 6 depicts a graphical representation 600 for a predictive collision analysis. In this example, the graphical representation 600 represents the interior of a virtual vehicle 602 within a virtual environment 604. The virtual environment 604 corresponds to a real-world environment, and the virtual vehicle 602 corresponds to a real-world vehicle in the real-world environment. The predictive collision analysis provides for a user to define the point of view of the simulation. For example, the user positions the camera during animation playback (e.g., playback of the simulation) from a driver's point of view, as shown by the graphical representation 600 in FIG. 5. That is, the graphical representation 600 shows what a driver of the real-world vehicle represented by the virtual vehicle 602 would see in the real-world environment. The graphical representation 600 shows a representation of a side-view mirror 606 of the real-world vehicle on the virtual vehicle 602. One shortcoming of the graphical representation 600 is that the view shows the forward view of the virtual environment 604 but no rear view that would be visible to the driver in rear-view mirror and/or side-view mirrors of the real-world vehicle. For example, as seen, the representation of the side-view mirror 606 does not actually show a mirrored view (or any view for that matter) of the virtual environment 604.

According to one or more embodiments described herein, a virtual mirror representation for predictive collision analysis is provided. The virtual mirror graphical representation includes a virtual side-view mirror, a virtual rear-view mirror, and/or the like including combinations and/or multiples thereof. According to one or more embodiments described herein, the virtual mirror representation uses existing 3D data to generate the virtual side-view and/or rear-view mirror(s). The virtual mirror graphical representation provides for animation playback that shows what the driver would have seen reflected by the real-world side-view and/or rear-view mirror(s) of the real-world vehicle. As a result, the predictive collision analysis is improved by providing a representation that more closely represents the real-world environment. The virtual mirror representation reduces the number of simulations performed because a user “sees” more information in a single simulation by viewing one or more side-view and/or rear-view mirrors. Accordingly, embodiments of the virtual mirror representation described herein provide a practical application by improving computer functionality because performing fewer simulations saves processing, memory, and data storage resources.

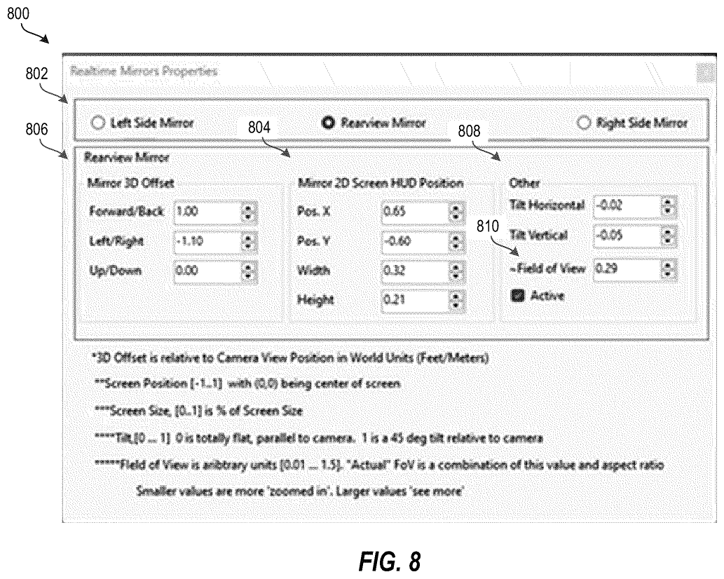

During configuration of a predictive collision analysis, a user defines one or more prediction properties using the prediction property engine 514. Those prediction properties are then used by the prediction/simulation analysis engine 516 to perform the predictive collision analysis. According to one or more embodiments described herein, the prediction properties includes defining a number and type of virtual mirrors (e.g., side-view and/or rear-view mirrors) and defining virtual mirror properties for each of the virtual mirrors. FIG. 8, described further herein, provides an interface 800 for defining virtual mirror properties for virtual mirrors.

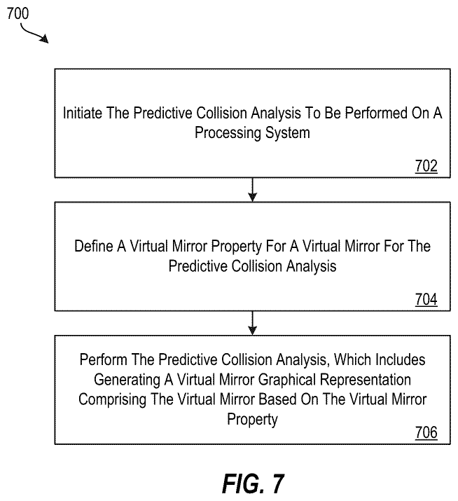

With continued reference to FIG. 5, the features and functionality of the data capture engine 512, the prediction property engine 514, the prediction/simulation analysis engine 516, and the virtual mirror graphical representation engine 518 are now described in more detail with reference to the following figures. For example, FIG. 7 depicts a flow diagram of a method 700 for a generating virtual mirror graphical representation for predictive collision analysis according to one or more embodiments described herein. The method 700 is performed by any suitable system and/or device, such as the processing system 500 of FIG. 5, the processing system 1100 of FIG. 11, and/or the like including combinations and/or multiples thereof. The method 700 is now described with reference to FIGS. 5, 6, 8, 9A-9D, and/or 10A-10C but is not so limited.

At block 702, the processing system 500 initiates the predictive collision analysis to be performed on the processing system 500. For example, a user of the user computing device 530 initiates the predictive collision analysis. According to one or more embodiments described herein, prior to initiating the predictive collision analysis, the data capture engine 512 is used to cause the 3D coordinate measurement device 520 and/or the camera 521 to capture data (e.g., the 3D data 509a) and/or images (e.g., the image data 509b) about the environment 522. According to one or more embodiments described herein, the 3D data 509a and/or the image data 509b is received from a data repository (e.g., a cloud data storage), having been previously captured and stored to the data repository. According to one or more embodiments described herein, the image data 509b is used to generate 3D data (e.g., the 3D data 509a) such as using photogrammetry and/or videogrammetry techniques.

At block 704, a virtual mirror property is defined for a virtual mirror for the predictive collision analysis. A virtual mirror property is one of multiple virtual mirror properties that together control how a virtual mirror presents information within the virtual environment of the predictive collision analysis. A user of the user computing device 530 defines one or more virtual mirror properties and/or one or more virtual properties are automatically set. For example, a user selects a type of vehicle (e.g., make and model) to be used in the predictive collision analysis, and one or more virtual mirror properties associated with the selected type of vehicle is automatically set for the predictive collision analysis. The user computing device 530 includes any suitable computing device (e.g., processing system) such as the processing system 1100 of FIG. 11. The user computing device 530 is a smartphone, laptop, tablet computer, desktop computer, wearable computing device, and/or the like including combinations and/or multiples thereof.

According to one or more embodiments described herein, the virtual mirror property (or properties) includes defining a number and a type of virtual mirrors. For example, the user selects one or more virtual mirrors to be included in the predictive collision analysis and assigns a type to each of the virtual mirrors (e.g., a left side-view mirror, a right side-view mirror, a rear-view mirror, and/or the like including combinations and/or multiples thereof). It should be appreciate that multiple virtual mirrors of the same type are defined. For example, two left side-view mirrors are defined. This is useful for simulation collisions involving vehicles that include two mirrors on the same side, such as semi-trucks, buses, and/or the like. According to one or more embodiments described herein, the user defines multiple virtual mirror properties for each of the number of and type of virtual mirrors.

An example of an interface 800 for defining virtual mirror properties for virtual mirrors is shown in FIG. 8 according to one or more embodiments described herein. A user selects which virtual mirror (e.g., left side-view mirror, right side-view mirror, rear-view mirror) for which to adjust properties at selection box 802. Non-limiting examples of virtual mirror properties include: a position of virtual mirrors within the digital representation (e.g., the graphical representation 600), which is referred to as a heads-up display (HUD) position (e.g., mirror 3D screen HUD position 804); a mirror offset that defines the position of a virtual camera sensor used to generate the virtual mirror(s) (e.g., mirror 3D offset); an orientation of the virtual mirror(s), which changes the view the user sees when viewing the virtual mirrors (e.g., other 806); and/or other properties, such as a zoom, field of view, and/or the like including combinations and/or multiples thereof. According to one or more embodiments described herein, the 3D offset is relative to a camera view position in world units (e.g., feet, meters). According to one or more embodiments described herein, the screen position includes a position X value and a position Y value, where each value is defined relative to an origin of the graphical representation, such as the center of the graphical representation. The position X value and/or the position Y value are defined as being [−1 . . . 1]. The width and height values define a screen size, which is a percentage of the screen size (e.g., [0 . . . 1]). According to one or more embodiments described herein, during configuration of a predictive collision analysis, a user selects a type of vehicle (e.g., make and model), which has preset properties for side-view and/or rear-view mirrors, such as the location of the mirrors relative to the vehicle. In some cases, the user defines a position of a virtual mirror relative to the graphical representation by clicking and dragging (e.g., performing a “drop and drag”) the virtual mirror within the graphical representation, by selecting a virtual mirror and moving it relative to the graphical representation using an input device such as a mouse, touchpad, touch screen, or keyboard, using gestures, and/or the like including combinations and/or multiples thereof.

With continued reference to FIG. 7, at block 706, the processing system 500 using the prediction/simulation analysis engine 516, performs the predictive collision analysis. Performing the predictive collision analysis includes generating, using the virtual mirror graphical representation engine 518, a virtual mirror graphical representation that includes the virtual mirror based on the virtual mirror property. FIGS. 9A-9D and 10A-10C show examples of a virtual mirror graphical representation that are included on a digital representation of an environment (e.g., the environment 522).

According to one or more embodiments described herein, the method 700 includes generating a digital representation (e.g., the graphical representation 600) of the predictive collision analysis. The digital representation includes the virtual mirror graphical representation as shown in FIGS. 9A-9D and 10A-10C. According to one or more embodiments described herein, the graphical representation includes multiple virtual mirror graphical representations (e.g., multiple a left side-view mirror, a right-side view mirror, a rear-view mirror, and/or the like including combinations and/or multiples thereof).

FIGS. 9A-9D are interfaces showing a graphical representation 900 for a predictive collision analysis where the graphical representation includes virtual mirror graphical representations 910, 912, 914 according to one or more embodiments described herein. In these examples, the graphical representation 900 includes three virtual mirror graphical representations 910, 912, 914, although other numbers of virtual mirror graphical representation is implemented in other examples. The virtual mirror graphical representation 910 represents a left side-view mirror, the virtual mirror graphical representation 912 represents a right side-view mirror, and the virtual mirror graphical representation 914 represents a rear-view mirror. Virtual mirror properties are defined, as described herein, using the interface 800 for defining virtual mirror properties for virtual mirrors as shown in FIG. 8 (see also FIGS. 9B and 9D). For example, the orientation of the virtual mirror graphical representation 912 is adjusted, as shown in FIGS. 9C and 9D to show different portions of the environment. For example, as is shown in FIG. 9D, a vehicle is shown in the virtual mirror graphical representation 912 that is in the “blind spot” of the virtual mirror graphical representation 912 of FIG. 9C. Further, as shown in FIG. 9C, virtual representations of subjects or objects, such as the virtual subject 920 is added to the predictive collision analysis by defining prediction properties, as described herein. This provides for more accurately simulation real-world conditions.

FIGS. 10A-10C are interfaces showing a graphical representation 1000 for a predictive collision analysis where the graphical representation includes virtual mirror graphical representations 1010, 1012, 1014 according to one or more embodiments described herein. In these examples, the graphical representation 1000 includes three virtual mirror graphical representations 1010, 1012, 1014, although other numbers of virtual mirror graphical representation is implemented in other examples. The virtual mirror graphical representation 1010 represents a left side-view mirror, the virtual mirror graphical representation 1012 represents a right side-view mirror, and the virtual mirror graphical representation 1014 represents a rear-view mirror. In this example, it is apparent how virtual objects outside a virtual vehicle 1020 move relative to the virtual vehicle 1020 as the simulation progresses from a first point in time (e.g., FIG. 10A) to a second point in time (e.g., FIG. 10B) to a third point in time (e.g., FIG. 10C). It should be appreciated that the virtual objects outside the virtual vehicle 1020 represent real-world objects relative to a real-world vehicle being represented by the virtual vehicle 1020 for purposes of performing the predictive collision analysis.

With continued reference to FIG. 7, according to one or more embodiments described herein, the method 700 includes defining prediction properties for the predictive collision analysis. For example, a user of the user computing device 530 uses the prediction property engine 514 of the processing system 500 to define prediction properties. Prediction properties define the operating parameters for the predictive collision analysis. For example, prediction properties define features of the environment, features of one or more vehicles, and/or other features. Non-limiting examples of features of the environment include weather conditions, time of day, type of road surface, road conditions, and/or the like including combinations and/or multiples thereof. Non-limiting examples of features of one or more vehicles include velocity, acceleration, direction of travel, lane of travel, and/or the like including combinations and/or multiples thereof.

Additional processes are also included, and it should be understood that the process depicted in FIG. 7 represents an illustration, and that other processes are added or existing processes are removed, modified, or rearranged without departing from the scope of the present disclosure.

It is understood that one or more embodiments described herein is capable of being implemented in conjunction with any other type of computing environment now known or later developed. For example, FIG. 11 depicts a block diagram of a processing system 1100 for implementing the techniques described herein. In accordance with one or more embodiments described herein, the processing system 1100 is an example of a cloud computing node of a cloud computing environment. In examples, processing system 1100 has one or more central processing units (“processors” or “processing resources” or “processing devices”) 1121a, 1121b, 1121c, etc. (collectively or generically referred to as processor(s) 1121 and/or as processing device(s)). In aspects of the present disclosure, each processor 1121 includes a reduced instruction set computer (RISC) microprocessor. Processors 1121 are coupled to system memory (e.g., random access memory (RAM) 1124) and various other components via a system bus 1133. Read only memory (ROM) 1122 is coupled to system bus 1133 and includes a basic input/output system (BIOS), which controls certain basic functions of processing system 1100.

Further depicted are an input/output (I/O) adapter 1127 and a network adapter 1126 coupled to system bus 1133. I/O adapter 1127 is a small computer system interface (SCSI) adapter that communicates with a hard disk 1123 and/or a storage device 1125 or any other similar component. I/O adapter 1127, hard disk 1123, and storage device 1125 are collectively referred to herein as mass storage 1134. Operating system 1140 for execution on processing system 1100 is stored in mass storage 1134. The network adapter 1126 interconnects system bus 1133 with an outside network 1136 enabling processing system 1100 to communicate with other such systems.

A display (e.g., a display monitor) 1135 is connected to system bus 1133 by display adapter 1132, which includes a graphics adapter to improve the performance of graphics intensive applications and a video controller. In one aspect of the present disclosure, adapters 1126, 1127, and/or 1132 are connected to one or more I/O busses that are connected to system bus 1133 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 1133 via user interface adapter 1128 and display adapter 1132. A keyboard 1129, mouse 1130, and speaker 1131 are interconnected to system bus 1133 via user interface adapter 1128, which includes, for example, a Super I/O chip integrating multiple device adapters into a single integrated circuit.

In some aspects of the present disclosure, processing system 1100 includes a graphics processing unit 1137. Graphics processing unit 1137 is a specialized electronic circuit designed to manipulate and alter memory to accelerate the creation of images in a frame buffer intended for output to a display. In general, graphics processing unit 1137 is very efficient at manipulating computer graphics and image processing, and has a highly parallel structure that makes it more effective than general-purpose CPUs for algorithms where processing of large blocks of data is done in parallel.

Thus, as configured herein, processing system 1100 includes processing capability in the form of processors 1121, storage capability including system memory (e.g., RAM 1124), and mass storage 1134, input means such as keyboard 11211 and mouse 1130, and output capability including speaker 1131 and display 1135. In some aspects of the present disclosure, a portion of system memory (e.g., RAM 1124) and mass storage 1134 collectively store the operating system 1140 to coordinate the functions of the various components shown in processing system 1100.

In addition to one or more of the features described herein, or as an alternative, further embodiments of the method includes that defining the virtual mirror property includes defining a plurality of virtual mirror properties.

In addition to one or more of the features described herein, or as an alternative, further embodiments of the method includes that the virtual mirror property includes a position of the virtual mirror within a digital representation of an environment including the virtual mirror graphical representation, a mirror offset that defines the position of a virtual camera sensor used to generate the virtual mirror, an orientation of the virtual mirror, a zoom of the virtual mirror, or a field of view of the virtual mirror.

In addition to one or more of the features described herein, or as an alternative, further embodiments of the method includes defining prediction properties for the predictive collision analysis.

In addition to one or more of the features described herein, or as an alternative, further embodiments of the method includes that defining the prediction properties includes defining a number and type of virtual mirrors.

In addition to one or more of the features described herein, or as an alternative, further embodiments of the method includes that the type of virtual mirrors is selected from a group consisting of a left side-view mirror, a right side-view mirror, and a rear-view mirror.

In addition to one or more of the features described herein, or as an alternative, further embodiments of the method includes that defining the virtual mirror property includes defining a plurality of virtual mirror properties for each of the number and the type of virtual mirrors.

In addition to one or more of the features described herein, or as an alternative, further embodiments of the method includes generating a digital representation of the predictive collision analysis, wherein the digital representation includes the virtual mirror graphical representation.

In addition to one or more of the features described herein, or as an alternative, further embodiments of the method includes that the digital representation including the virtual mirror graphical representation is displayed on a display of the processing system.

In addition to one or more of the features described herein, or as an alternative, further embodiments of the method includes that the digital representation includes a plurality of virtual mirror graphical representations.

In addition to one or more of the features described herein, or as an alternative, further embodiments of the method includes collecting the 3D data of an environment using a 3D coordinate measurement device, wherein the 3D data of the environment is used to perform the predictive collision analysis.

In addition to one or more of the features described herein, or as an alternative, further embodiments of the method includes that the 3D coordinate measurement device is a laser scanner that includes: a scanner processing system including a scanner controller; a housing; and a 3D scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.

In addition to one or more of the features described herein, or as an alternative, further embodiments of the method includes collecting images of an environment using a camera and generating 3D data of the environment based at least in part on the images by using a photogrammetry or videogrammetry technique,
wherein the 3D data of the environment is used to perform the predictive collision analysis.

In addition to one or more of the features described herein, or as an alternative, further embodiments of the processing system includes that the virtual mirror property includes a position of the virtual mirror within a digital representation of an environment including the virtual mirror graphical representation, a mirror offset that defines the position of a virtual camera sensor used to generate the virtual mirror, an orientation of the virtual mirror, a zoom of the virtual mirror, or a field of view of the virtual mirror.

In addition to one or more of the features described herein, or as an alternative, further embodiments of the processing system includes operations for defining prediction properties for the predictive collision analysis.

In addition to one or more of the features described herein, or as an alternative, further embodiments of the processing system includes that defining the prediction properties includes defining a number and type of virtual mirrors.

In addition to one or more of the features described herein, or as an alternative, further embodiments of the processing system includes that the type of virtual mirrors is selected from a group consisting of a left side-view mirror, a right side-view mirror, and a rear-view mirror.

In addition to one or more of the features described herein, or as an alternative, further embodiments of the processing system includes that defining the virtual mirror property includes defining a plurality of virtual mirror properties for each of the number and the type of virtual mirrors.

In addition to one or more of the features described herein, or as an alternative, further embodiments of the processing system includes that the operations further include generating a digital representation of the predictive collision analysis, wherein the digital representation includes the virtual mirror graphical representation.

It will be appreciated that one or more embodiments described herein may be embodied as a system, method, or computer program product and may take the form of a hardware embodiment, a software embodiment (including firmware, resident software, micro-code, etc.), or a combination thereof. Furthermore, one or more embodiments described herein may take the form of a computer program product embodied in one or more computer readable medium(s) having computer readable program code embodied thereon.

The term “about” is intended to include the degree of error associated with measurement of the particular quantity based upon the equipment available at the time of filing the application. For example, “about” can include a range of +8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A computer-implemented method for performing a predictive collision analysis, the method comprising:
initiating, on a processing system, the predictive collision analysis to be performed on the processing system, the predictive collision analysis is based on an environment of a vehicle collision;
defining a virtual mirror property for a virtual mirror for the predictive collision analysis, the virtual mirror depicting rear views of a vehicle in the vehicle collision; and
performing, by the processing system, the predictive collision analysis, wherein performing the predictive collision analysis includes generating a virtual mirror graphical representation comprising the virtual mirror based on the virtual mirror property.

2. The computer-implemented method of claim 1, wherein defining the virtual mirror property comprises defining a plurality of virtual mirror properties.

3. The computer-implemented method of claim 1, wherein the virtual mirror property comprises a position of the virtual mirror within a digital representation of an environment comprising at least one of:
the virtual mirror graphical representation;
a mirror offset that defines the position of a virtual camera sensor used to generate the virtual mirror;
an orientation of the virtual mirror;
a zoom of the virtual mirror; and
a field of view of the virtual mirror.

4. The computer-implemented method of claim 1, further comprising defining prediction properties for the predictive collision analysis.

5. The computer-implemented method of claim 4, wherein defining the prediction properties comprises defining a number and type of virtual mirrors.

6. The computer-implemented method of claim 5, wherein the type of virtual mirrors is selected from a group comprising:
a left side-view mirror;
a right side-view mirror; and
a rear-view mirror.

7. The computer-implemented method of claim 5, wherein defining the virtual mirror property comprises defining a plurality of virtual mirror properties for each of the number and the type of virtual mirrors.

8. The computer-implemented method of claim 1, further comprising generating a digital representation of the predictive collision analysis, wherein the digital representation includes the virtual mirror graphical representation.

9. The computer-implemented method of claim 8, wherein the digital representation including the virtual mirror graphical representation is displayed on a display of the processing system.

10. The computer-implemented method of claim 8, wherein the digital representation includes a plurality of virtual mirror graphical representations.

11. The computer-implemented method of claim 1, further comprising collecting the 3D data of an environment using a 3D coordinate measurement device, wherein the 3D data of the environment is used to perform the predictive collision analysis.

12. The computer-implemented method of claim 11, wherein the 3D coordinate measurement device is a laser scanner that comprises:
a scanner processing system including a scanner controller;
a housing; and
a 3D scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.

13. The computer-implemented method of claim 1, further comprising collecting images of an environment using a camera and generating 3D data of the environment based at least in part on the images by using a photogrammetry or videogrammetry technique, wherein the 3D data of the environment is used to perform the predictive collision analysis.

14. A processing system comprising:
a memory comprising computer readable instructions; and
a processing device for executing the computer readable instructions, the computer readable instructions controlling the processing device to perform operations for performing a predictive collision analysis, the operations comprising:
initiating the predictive collision analysis to be performed;
defining a virtual mirror property for a virtual mirror for the predictive collision analysis; and
performing the predictive collision analysis, wherein performing the predictive collision analysis includes generating a virtual mirror graphical representation comprising the virtual mirror based on the virtual mirror property.

15. The processing system of claim 14, wherein the virtual mirror property comprises a position of the virtual mirror within a digital representation of an environment comprising at least one of:
the virtual mirror graphical representation;
a mirror offset that defines the position of a virtual camera sensor used to generate the virtual mirror;
an orientation of the virtual mirror;
a zoom of the virtual mirror; and
a field of view of the virtual mirror.

16. The processing system of claim 14, further comprising defining prediction properties for the predictive collision analysis.

17. The processing system of claim 16, wherein defining the prediction properties comprises defining a number and type of virtual mirrors.

18. The processing system of claim 17, wherein the type of virtual mirrors is selected from a group comprising:
a left side-view mirror;
a right side-view mirror; and
a rear-view mirror.

19. The processing system of claim 17, wherein defining the virtual mirror property comprises defining a plurality of virtual mirror properties for each of the number and the type of virtual mirrors.

20. The processing system of claim 14, wherein the operations further comprise generating a digital representation of the predictive collision analysis, wherein the digital representation includes the virtual mirror graphical representation.
